(19) United States
(12) Patent Application Publication
(10) Pub. No.: US 2010/0151894 A1
(43) Pub. Date: Jun. 17, 2010

(54) APPARATUS AND METHOD FOR OPERATING RESOURCE OF SMALL CELL IN WIRELESS COMMUNICATION SYSTEM

(75) Inventors: Chang-Yoon OH, Suwon-si (KR); Young-Bo CHO, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/635,996

(22) Filed: Dec. 11, 2009

(30) Foreign Application Priority Data
Dec. 12, 2008 (KR) 10-2008-0126315

(51) Int. Cl. H04B 15/00; H04W 72/04

(52) U.S. Cl. 455/509; 455/63.1

(57) ABSTRACT

An apparatus and a method for avoiding small cell interference in a wireless communication system which includes a macro Base Station (BS) and at least one small BS using the same frequency band are provided. The method includes, when receiving an interference avoidance resource request signal from at least one terminal to which a macro cell service is provided, determining a small BS which exerts interference on the terminal, determining an interference avoidance interval not used by the small BS which exerts the interference on the terminal, and allocating a resource to the terminal using a resource of the interference avoidance interval not used by the small BS.

### PRIORITY

This application claims the benefit under 35 U.S.C. §119(a) of a Korean patent application filed in the Korean Intellectual Property Office on Dec. 12, 2008 and assigned Serial No. 10-2008-0126315, the entire disclosure of which is hereby incorporated by reference.

### BACKGROUND OF THE INVENTION

1. Field of the Invention

The present invention relates to an apparatus and a method for operating a small cell in a wireless communication system. More particularly, the present invention relates to an apparatus and a method for cancelling interference of the small cell in the wireless communication system including a macro cell and the small cell.

2. Description of the Related Art

A mobile communication terminal and a base station may not communicate smoothly with each other for any of several reasons. For example, communication may not be smooth because of geographical conditions in a cell of a wireless communication system, excessive distance between the terminal and the base station, movement of the terminal, and the like.

To address this problem, the wireless communication system provides a small cell service. A conventional wireless communication system including a macro cell and small cells is shown in FIG. 1.

FIG. 1 depicts a conventional wireless communication system including a macro cell and small cells.

The wireless communication system of FIG. 1 includes a macro base station 100, small base station 1 110, small base station 2 120, small base station 3 130 and small base station 4 140. Herein, small cells managed by the small base stations 110 through 140 reside in a macro cell managed by the macro base station 100.

When the macro cell and the small cells utilize the same frequency band in the wireless communication system as established above, the service from the macro base station is considerably interfered by the small cells in the boundary area between the macro cell and the small cell.

To provide a seamless communication service, the wireless communication system supports handover between the macro cell and the small cell. However, since many small cells reside in the macro cell and the size of the small cell is quite small, a terminal that is in motion must frequently hand over and thus increases the overhead due to the signaling that is necessary for handover.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for cancelling interference of a small cell in a wireless communication system including a macro cell and a small cell which use the same frequency band.

Another aspect of the present invention is to provide an apparatus and a method for setting an interference avoidance interval so that a terminal receiving a macro cell service is not interfered by a small cell in a wireless communication system including a macro cell and the small cell.

Yet another aspect of the present invention is to provide an apparatus and a method for setting a difference interference avoidance interval per group of small base stations in a wireless communication system including a macro cell and the small cell.

Still another aspect of the present invention is to provide an apparatus and a method setting an interference avoidance interval for providing a macro cell service to a terminal in a small cell in a wireless communication system including a macro cell and the small cell.

In accordance with an aspect of the present invention, a method for avoiding small cell interference at a macro Base Station (BS) in a wireless communication system which comprises the macro BS and at least one small BS using the same frequency band is provided. The method includes, when receiving an interference avoidance resource request signal from at least one terminal to which a macro cell service is provided, determining a small BS which exerts interference on the terminal, determining an interference avoidance interval not used by the small BS which exerts the interference on the terminal, and allocating a resource to the terminal using the resource of the interference avoidance interval not used by the small BS.

In accordance with another aspect of the present invention, a method for avoiding small cell interference at a terminal in a wireless communication system which comprises a macro BS and at least one small BS using the same frequency band is provided. The method includes, when receiving a service from the macro BS, determining a signal strength of the macro BS and the at least one small BS, determining whether there is a small BS which exerts interference, by determining the signal strength of the macro BS and the at least one small BS, and, if it is determined that the small BS is exerting interference, requesting the macro BS to allocate a resource of an interference avoidance interval unusable by the small BS.

In accordance with yet another aspect of the present invention, an apparatus for avoiding small cell interference at a macro BS in a wireless communication system which comprises the macro BS and at least one small BS using the same frequency band is provided. The apparatus includes a receiver for receiving a signal, and a controller for, when receiving an interference avoidance resource request signal from at least one terminal to which a macro cell service is provided, through the receiver, determining an interference avoidance interval not used by the small BS which exerts the interference on the terminal and for allocating a resource to the terminal using a resource of the interference avoidance interval not used by the small BS.

In accordance with still another aspect of the present invention, an apparatus for avoiding small cell interference at a terminal in a wireless communication system which comprises a macro BS and at least one small BS using the same frequency band is provided. The apparatus includes a receiver for receiving a signal, an interference examiner for determining whether there is a small BS which exerts interference, by taking into account a signal strength of the macro BS and the at least one small BS acquired using the signal received through the receiver, a controller for, if it is determined that the small BS is exerting interference, requesting the macro BS to allocate a resource of an interference avoidance interval not usable by the small BS, and a transmitter for requesting the macro BS to allocate the resource of the interference avoidance interval under control of the controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a conventional wireless communication system including a macro cell and small cells;

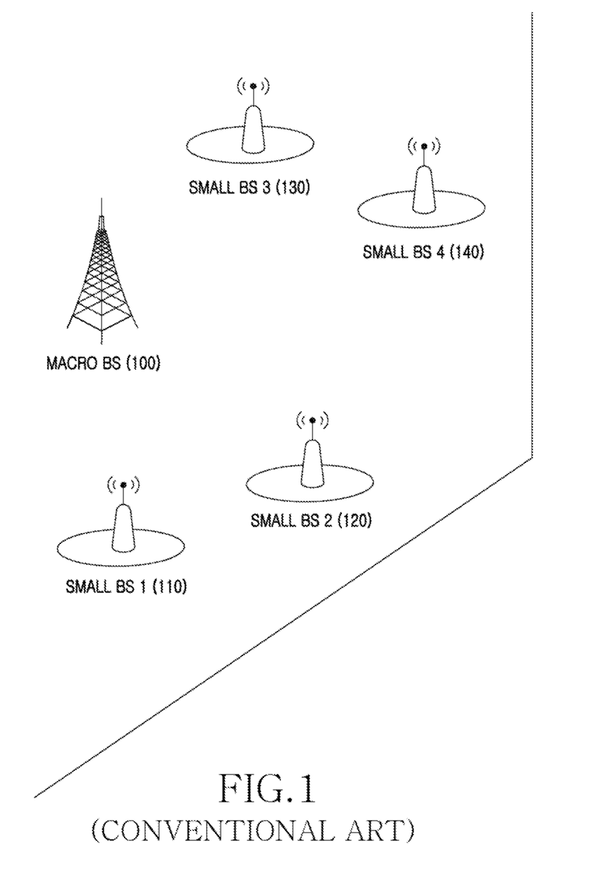

FIGS. 2A and 2B illustrate frame structures for interference cancellation in a wireless communication system according to an exemplary embodiment of the present invention;

FIG. 3 illustrates a wireless communication system including a macro cell and small cells according to an exemplary embodiment of the present invention;

FIG. 4 illustrates frame structures for interference cancellation in a wireless communication system according to an exemplary embodiment of the present invention;

FIG. 5 illustrates a method for allocating resources at a macro base station according to an exemplary embodiment of the present invention;

FIG. 6 illustrates a method for cancelling interference of a small base station at a terminal serviced by a macro base station according to an exemplary embodiment of the present invention;

FIG. 7 illustrates a method for allocating resources at a macro base station according to an exemplary embodiment of the present invention;

FIG. 8 illustrates a method for cancelling interference of a small base station at a terminal serviced by a macro base station according to an exemplary embodiment of the present invention;

FIG. 9 illustrates a method for allocating resources at a macro base station according to an exemplary embodiment of the present invention;

FIG. 10 illustrates a method for cancelling interference of a small base station at a terminal serviced by a macro base station according to an exemplary embodiment of the present invention;

FIG. 11 illustrates a macro base station according to an exemplary embodiment of the present invention; and

FIG. 12 illustrates a terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for cancelling small cell interference which affects a terminal receiving service from a macro cell in a wireless communication system including the macro cell and one or more small cells. Herein, the one or more small cells reside in a service coverage area of the macro cell and is assumed to utilize the same frequency band as the macro cell.

Henceforth, it is assumed that the wireless communication system adopts a Time Division Duplex (TDD) scheme. Furthermore, an interference avoidance interval is defined in a downlink subframe including 4 mini frames by way of example, the interference avoidance interval can be set in the uplink subframe and other downlink subframes in the same manner. A terminal serviced by a macro Base Station (BS) is referred to as a macro terminal, and a group of small BSs is referred to as a small BS group.

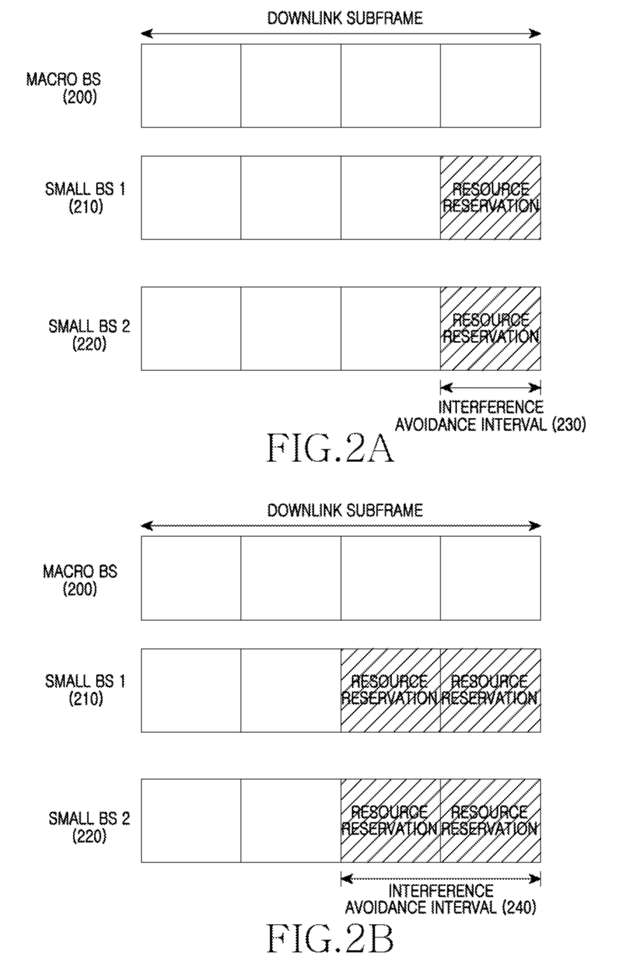

To address the small cell interference affecting the macro terminal, the wireless communication system sets an interference avoidance interval which can be used only by the macro BS as shown in FIGS. 2A and 2B.

FIG. 2A and FIG. 2B illustrate frame structures for interference cancellation in a wireless communication system according to an exemplary embodiment of the present invention.

Referring to FIG. 2A, a downlink subframe includes an interference avoidance interval 230. Referring to FIG. 2B, a downlink subframe includes an extended interference avoidance interval 240. In each of FIG. 2A and FIG. 2B, a small BS 1 210 and a small BS 2 220 reside in a macro cell managed by a macro BS 200.

Referring again to FIG. 2A, the macro BS 200 sets one mini frame as the interference avoidance interval 230 for both the small BSs 210 and 220.

The small BSs 210 and 220 do not use the resource of the interference avoidance interval 230. Hence, the macro BS 200 allocates the resource of the interference avoidance interval 230 to the macro terminal interfered by the small BSs 210 and 220 and thus addresses the small cell interference.

The wireless communication system defines the interference avoidance interval 230 to address the small cell interference with respect to the macro terminal. In so doing, the size of the interference avoidance interval 230 can be fixed or variable. For example, when the number of macro terminals receiving interference from the small cell increases, the macro BS 200 can extend the interference avoidance interval 230 as shown in FIG. 2B by requesting the small BSs 210 and 220 to extend the interference avoidance interval 230.

Referring again to FIG. 2B, the macro BS 200 defines two mini frames as the interference avoidance interval 240 to be equally operated by the small BSs 210 and 220.

The small BSs 210 and 220 do not use the resource of the interference avoidance interval 240. Hence, the macro BS 200 allocates the resource of the interference avoidance interval 240 to the macro terminals receiving interference from the small BSs 210 and 220 and thus addresses the small cell interference.

The small BSs in the cell of the macro BS 200 designate the same resource region as the interference avoidance interval.

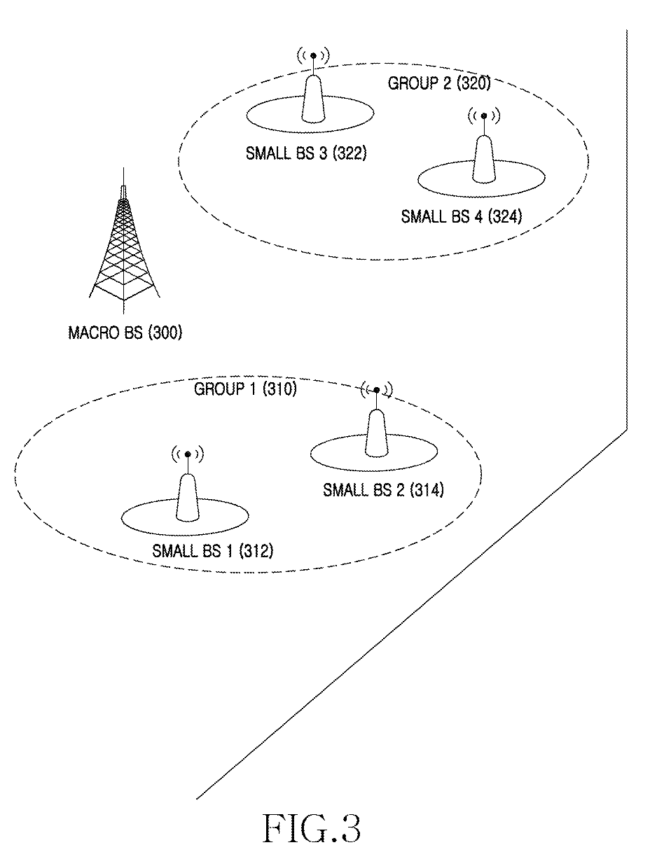

According to an exemplary embodiment of the present invention, the small BSs may designate different resource regions as the interference avoidance interval on a group basis. The macro BS can group the small BSs in its cell coverage into a plurality of groups as shown in FIG. 3.

FIG. 3 depicts a wireless communication system including a macro cell and small cells according to an exemplary embodiment of the present invention.

The wireless communication system of FIG. 3 includes a macro BS 300 and small BSs 312, 314, 322 and 324.

The macro BS 300 groups the small BSs 312, 314, 322 and 324 in its macro cell into two groups 310 and 320. For example, by taking into account location information of the small BSs 312, 314, 322 and 324, the macro BS 300 groups the first small BS 312, which is adjacent to the macro BS 300, and the second small BS 314 to the first group 310 and groups the third small BS 322, which is adjacent to the macro BS 300, and the fourth small BS 324 to the second group 320.

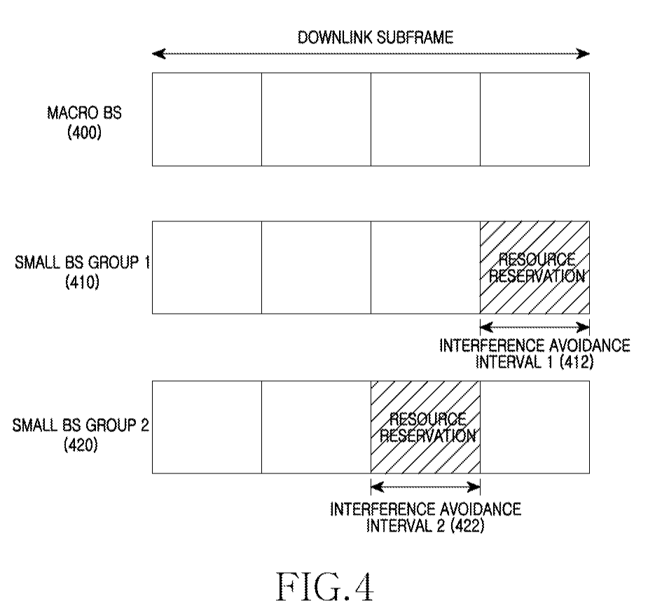

The macro BS 300 sets the different resource regions as the interference avoidance interval for the respective groups 310 and 320. For example, the macro BS 300 defines different resource regions as interference avoidance intervals for the respective groups 310 and 320 as shown in FIG. 4.

FIG. 4 depicts frame structures for interference cancellation in a wireless communication system according to an exemplary embodiment of the present invention.

Referring to FIG. 4, a macro BS 400 sets interference avoidance intervals 412 and 422 of different time resources for the small BS groups 410 and 420 residing in its cell coverage area. For example, the macro BS 400 defines the fourth mini frame as the first interference avoidance interval 412 of the first small BS group 410 and the third mini frame as the second interference avoidance interval 422 of the second small BS group 420.

The small BSs of the first small BS group 410 do not use the resource of the first interference avoidance interval 412, and the small BSs of the second small BS group 420 do not use the resource of the second interference avoidance interval 422. Hence, the macro BS 400 can allocate the resource of the first interference avoidance interval 412 to the macro terminal affected by the interference of the small BS of the first small BS group 410 and thus address the small cell interference. Also, the macro BS 400 can allocate the resource of the second interference avoidance interval 422 to the macro terminal affected by the interference of the small BS of the second small BS group 420 and thus address the small cell interference.

As stated above, to raise the resource efficiency of the small BSs, the macro BS sets the interference avoidance intervals such that the interference avoidance intervals of the small BS groups do not overlap each other. An exemplary method for operating the interference avoidance interval depends on whether or not the macro BS transmits small BS group information.

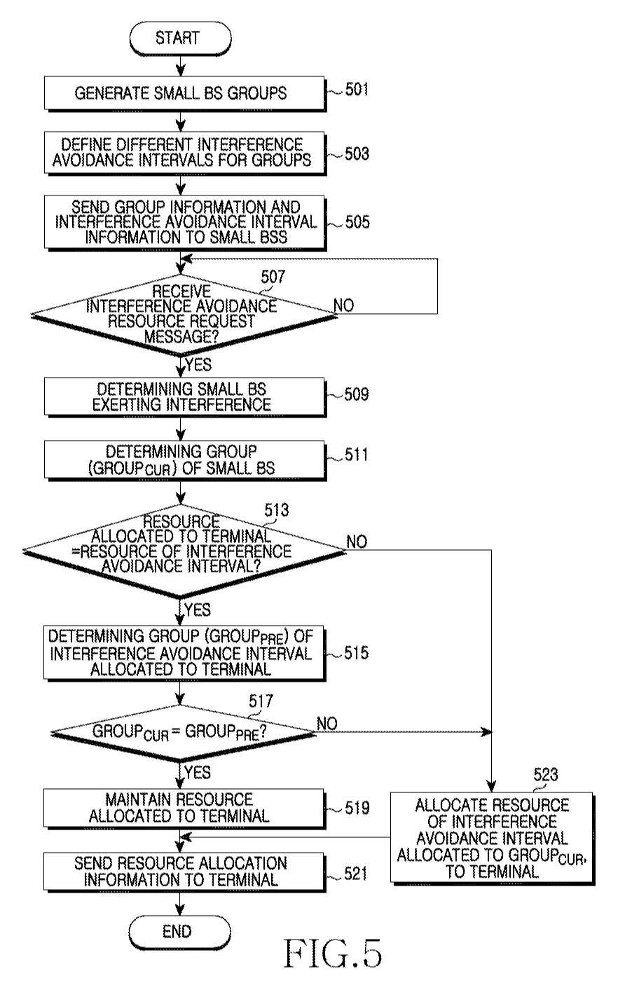

When not transmitting the small BS group information to terminals of the macro cell, the macro BS may operate the interference avoidance interval as shown in FIG. 5.

FIG. 5 illustrates a method for allocating resources at a macro BS according to an exemplary embodiment of the present invention.

Referring to FIG. 5, in step 501 the macro BS generates one or more groups with the small BSs in its cell coverage area. For instance, the macro BS generates the groups of the small BSs by taking into account location information provided from the small BSs in its cell coverage area. The macro BS allocates a group ID, which is a unique identifier, to each small BS group.

In step 503, the macro BS sets the interference avoidance interval for the small BS groups generated in step 501. At this time, the macro BS defines the interference avoidance interval of each small BS group such that the interference avoidance intervals of the small BS groups do not overlap each other. For example, the macro BS sets the interference avoidance intervals of the small BS groups not to overlap each other as shown in FIG. 4.

In step 505, the macro BS transmits the group ID of the small BS group and the interference avoidance interval information of the small BS group to the small BSs positioned in the cell. For example, the macro BS transmits the group ID of the small BS group and the interference avoidance interval information defined in the small BS group to the small BSs positioned in the cell over a wired network or a backhaul. Accordingly, the small BSs can determine their small BS group and obtain the interference avoidance interval information of the corresponding small BS group, from the information received from the macro BS.

In step 507, the macro BS determines whether an interference avoidance resource request message is received from the macro terminal. Herein, the interference avoidance resource request message may include small BS information which interferes with the macro terminal.

If it is determined in step 507 that the interference avoidance resource request message is received from the macro terminal, the macro BS determines the small BS which interferes with the macro terminal based on the interference avoidance resource request message in step 509. For example, the macro BS determines a physical layer ID or a Media Access Control (MAC) layer ID of the small BS which interferes with the macro terminal. Herein, the physical layer ID indicates a cell ID and the MAC layer ID indicates a BS ID.

In step 511, the macro BS determines the small BS group including the small BS determined in step 509.

In step 513, the macro BS determines whether the resource of the interference avoidance interval is allocated to the macro terminal. That is, the macro BS determines whether the resource of the interference avoidance interval of the small BS group determined in step 511 is allocated to the macro terminal.

If it is determined in step 513 that the resource of the interference avoidance interval is not allocated to the macro terminal, the macro BS allocates the resource defined as the interference avoidance interval of the small BS group determined in step 511, to the macro terminal in step 523. When fixedly allocating the resource of the macro terminal with the resource different from the resource set as the interference avoidance interval, the macro BS changes the fixed resource of the macro terminal to the resource set as the interference avoidance interval of the small BS group determined in step 511.

On the other hand, if it is determined in step 513 that the resource of the interference avoidance interval is allocated to the macro terminal, the macro BS proceeds to step 515. To allocate the resource defined as the interference avoidance interval to the macro terminal, the macro BS determines the small BS group which operates the resource allocated to the macro terminal as the interference avoidance interval in step 515.

In step 517, the macro BS determines whether the small BS group determined in step 511 is the same small BS group as determined in step 515.

If it is determined that the small BS groups are different in step 517, the macro BS allocates the resource determined as the interference avoidance interval of the small BS group determined in step 511, to the macro terminal in step 523.

On the other hand, if it is determined that the small BS groups are substantially identical in step 517, the macro BS maintains the resource allocated to the macro terminal in step 519.

After allocating the resource to the macro terminal in step 519 or step 523, the macro BS transmits resource allocation information to the macro terminal in step 521. When the fixed resource is allocated to the macro terminal, the macro BS transmits the resource allocation information to the terminal only in the resource allocated to the terminal in step 523.

Next, the macro BS finishes this process.

As described above, the macro BS defines the interference avoidance intervals of the small BS groups not to overlap each other. In so doing, the macro BS may update the small BS groups on a periodic basis or when an addition/removal event of the small BS occurs.

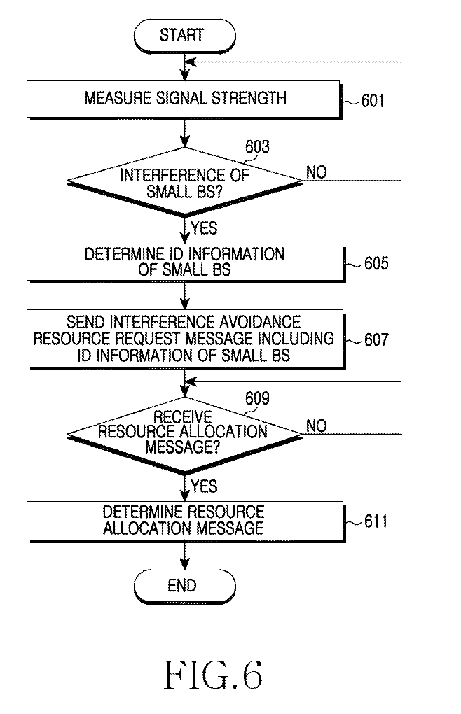

When the macro BS does not transmit the small BS group information, the macro terminal functions as shown in FIG. 6.

FIG. 6 illustrates a method for cancelling interference of a small BS at a terminal serviced by a macro BS according to an exemplary embodiment of the present invention.

Referring to FIG. 6, in step 601 a terminal measures the signal strength of a macro BS servicing the terminal and one or more small BSs. For example, the terminal measures the signal strength using Synchronous CHannel (SCH) or a preamble transmitted from the macro BS and one or more small BSs. Herein, the signal strength includes Carrier to Interference and Noise Ratio (CINR) or Received Signal Strength Indication (RSSI).

In step 603, the terminal determines if interference is received from the small BS. For example, the terminal compares the average signal strength of the macro BS measured for a certain time period with the average signal strength of the small BS. When the average signal strength of the macro BS is lower than the average signal strength of the small BS by more than a reference value, the terminal recognizes the signal received from the small BS as small BS interference. Alternatively, when the movement speed of the terminal is greater than a reference speed and the average signal strength of the macro BS measured for a certain time period is lower than the average signal strength of the small BS by more than the reference value, the terminal recognizes the signal received from the small BS as small BS interference. Herein, the reference value is a positive number including zero.

If it is determined in step 603 that interference from the small BS does not occur, the terminal returns to step 601 and re-measures the signal strength of the macro BS servicing the terminal and the one or more small BSs.

On the other hand, if it is determined in step 603 that interference from the small BS does occur, the terminal determines the ID information of the small BS exerting the interference in step 605. For example, the terminal can determine the ID information from the physical layer ID of the small BS using the SCH or the preamble. When the macro BS cannot determine the small BS merely with the cell ID, the terminal needs to determine the unique BS ID of the small BS. The terminal may determine the BS ID of the small BS using the mapping information of the cell ID provided from the macro BS and the BS ID and the cell ID of the small BS determined from the SCH or the preamble. Alternatively, the terminal can determine the cell ID of the small BS through the SCH or the preamble. Next, the terminal may be able to determine the BS ID of the small BS through a Broadcast CHannel (BCH) of the small BS decoded using the cell ID.

After determining the ID information of the small BS exerting the interference in step 605, the terminal sends an interference avoidance resource request message including the ID information of the small BS to the macro BS in step 607.

In step 609, the terminal determines whether a resource allocation message is received from the macro BS.

If it is determined in step 609 that a resource allocation message is received, the terminal determines the resource allocated from the macro BS based on the resource allocation message in step 611. On the other hand, if it is determined in step 609 that a resource allocation message is not received, the terminal continues performing step 609.

Next, the terminal finishes this process.

In this exemplary embodiment, the macro BS does not transmit the small BS group information to the macro terminals.

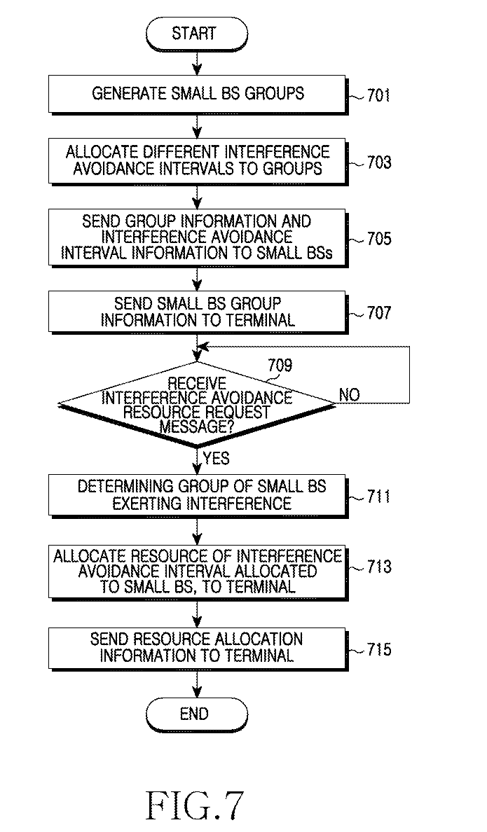

According to an exemplary embodiment of the present invention, the macro BS may transmit the small BS group information to the macro terminals. In this case, the macro BS operates the interference avoidance interval as shown in FIG. 7.

FIG. 7 illustrates a method for allocating resources at a macro BS according to an exemplary embodiment of the present invention.

Referring to FIG. 7, in step 701 the macro BS generates one or more groups with the small BSs positioned in its cell coverage area. For example, the macro BS generates the groups of small BSs by taking into account the location information provided from the small BSs positioned in its cell coverage area. The macro BS allocates a group ID, which is a unique ID, to each small BS group.

In step 703, the macro BS defines the interference avoidance intervals for the small BS groups generated in step 701. The macro BS sets the interference avoidance intervals for the small BS groups not to overlap each other. For example, the macro BS sets the interference avoidance intervals of the small BS groups not to overlap each other as shown in FIG. 4.

In step 705, the macro BS transmits the group ID of the small BS group and the interference avoidance interval information of the small BS group to the small BSs positioned in the cell. For example, the macro BS transmits the group ID of the small BS group and the interference avoidance interval information defined in the small BS group to the small BSs positioned in the cell over the wired network or the backhaul. Alternatively, the macro BS transmits only the interference avoidance interval information defined in the small BS group to the small BSs positioned in the service coverage area over the wired network or the backhaul. Accordingly, the small BSs can determine their small BS group and obtain the interference avoidance interval information of the corresponding small BS group, from the information received from the macro BS.

In step 707, the macro BS transmits the small BS group information to the macro terminals. For example, the macro BS periodically transmits the small BS group information using the BCH or the MAC operation message. Alternatively, when the small BS group information is changed using the BCH or the MAC operation message, the macro BS may transmit the small BS group information. Herein, the small BS group information includes the ID of the small BS and the group ID information of the small BS group including the small BSs.

In step 709, the macro BS determines whether the interference avoidance resource request message is received from the macro terminal.

If it is determined in step 709 that the interference avoidance resource request message is received, the macro BS determines the group ID of the small BS exerting interference on the macro terminal in step 711. On the other hand, if it is determined in step 709 that the interference avoidance resource request message is not received, the macro BS continues execution of step 709.

In step 713, the macro BS allocates the resource to the terminal using the resource defined as the interference avoidance interval of the small BS group determined in step 711. When allocating the fixed resource to the terminal, the macro BS changes the fixed allocation resource of the terminal to the resource set as the interference avoidance interval of the small BS group determined in step 711.

In step 715, the macro BS transmits the resource allocation information to the terminal.

Next, the macro BS finishes this process.

As such, the macro BS defines the interference avoidance intervals of the small BS groups not to overlap each other. In so doing, the macro BS may update the small BS groups on a periodic basis or when an addition/removal event of the small BS occurs.

According to an exemplary embodiment of the present invention, the macro BS determines the group ID of the small BS exerting the interference on the macro MS based on the interference avoidance resource request message.

Alternatively, the macro BS may determine the ID of the small BS exerting the interference on the macro terminal, from the interference avoidance resource request message. In this situation, the macro BS can determine the ID of the small BS exerting the interference on the macro terminal, from the interference avoidance resource request message. The macro BS may determine the small BS group including the small BS according to the small BS group information generated in step 701.

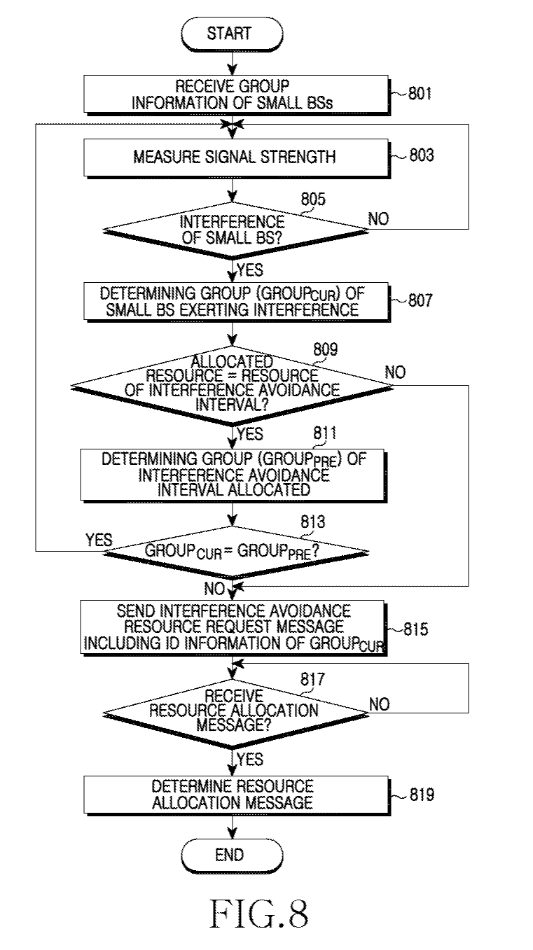

When the macro BS sends the small BS group information as described above, the macro terminal functions as shown in FIG. 8.

FIG. 8 illustrates a method for cancelling interference of a small BS at a terminal serviced by a macro BS according to an exemplary embodiment of the present invention.

Referring to FIG. 8, in step 801 a terminal receives small BS group information from a macro BS which provides service to the terminal. For example, the terminal receives the small BS group information periodically transmitted from the macro BS, using the BCH, the MAC operation message, or other methods. Herein, the small BS group information includes the ID of the small BS and the group ID information of the small BS group including the small BS. The ID of the small BS includes the cell ID which is the physical layer ID, and the BS ID which is the MAC layer ID.

In step 803, the terminal measures the signal strength of the macro BS providing the service and at least one small BS. For example, the terminal measures the signal strength using the SCH or the preamble transmitted from the macro BS and the small BS. Herein, the signal strength includes the CINR or the RSSI.

In step 805, the terminal determines if there is interference from the small BS. For example, the terminal compares the average signal strength of the macro BS measured for a certain time period with the average signal strength of the neighbor small BS. When the average signal strength of the macro BS is lower than the average signal strength of the small BS by more than a reference value, the terminal recognizes the signal received from the small BS as interference. Alternatively, when the movement speed of the terminal is greater than a reference speed and the average signal strength of the macro BS measured for a certain time period is lower than the average signal strength of the neighbor small BS by more than the reference value, the terminal recognizes the signal received from the small BS as small BS interference. Herein, the reference value is a positive number including zero.

If it is determined in step 805 that there is no small BS interference, the terminal returns to step 803 and re-measures the signal strength of the macro BS providing the service and the small BSs. The terminal can measure the signal strength of the macro BS and the small BSs on a periodic basis.

In contrast, if it is determined in step 805 that there is interference from the small BS, the terminal determines the group of the small BS which exerts the interference in step 807. The terminal determines the group of the small BS which exerts the interference using the small BS group information received in step 801.

In step 809, the terminal determines whether the resource allocated from the macro BS is the resource of the interference avoidance interval determined by the macro BS.

If it is determined in step 809 that the resource allocated from the macro BS is not the resource of the interference avoidance interval, the terminal sends the interference avoidance resource request message including the group ID information of the small BS group determined in step 807, to the macro BS in step 815.

On the other hand, if it is determined in step 809 that the resource allocated from the macro BS is the resource of the interference avoidance interval, the terminal determines the small BS group which operates the resource allocated from the macro BS as the interference avoidance interval in step 811.

In step 813, the terminal compares the small BS group determined in step 807 with the small BS group determined in step 811.

If it is determined in step 813 that the small BS groups compared are substantially identical, the terminal returns to step 803 and re-measures the signal strength of the macro BS providing the service and the neighboring small BSs. In more detail, when the small BS groups compared in step 813 are substantially identical, the small BSs of the same small BS group operate using the same interference avoidance interval. Naturally, the terminal can avoid interference from the small BS even using the resource pre-allocated from the macro BS.

If it is determined in step 813 that the small BS groups compared are not substantially identical, the terminal sends the interference avoidance resource request message including the group ID information of the small BS group determined in step 807, to the macro BS in step 815.

In step 817, the terminal determines whether the resource allocation message is received from the macro BS.

If it is determined in step 817 that the resource allocation message is received, the terminal determines the resource allocated from the macro BS based on the resource allocation message in step 819.

Alternatively, if it is determined in step 817 that the resource allocation message is not received, the terminal continues execution of step 817.

Next, the terminal finishes this process.

In an exemplary embodiment, the terminal sends the interference avoidance resource request message including the group ID information of the small BS group including the small BS which exerts the interference, to the macro BS.

In yet another exemplary embodiment, the terminal may send the interference avoidance resource request message including the ID information of the small BS which exerts the interference, to the macro BS.

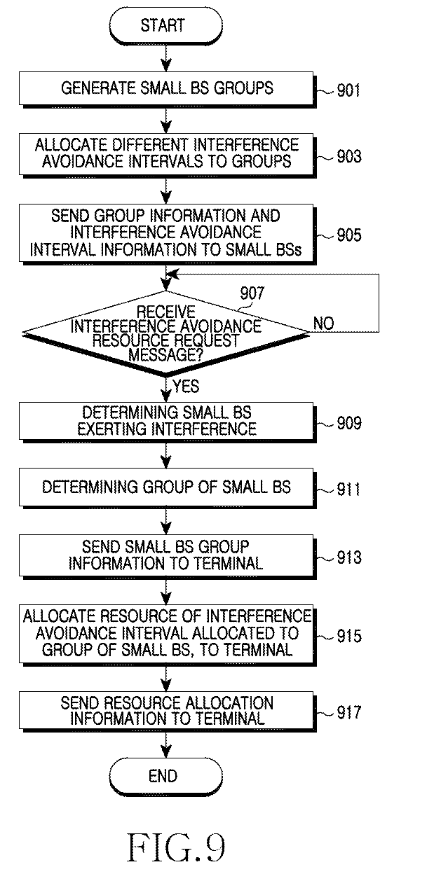

When the macro BS sends the small BS group information according to the request of the terminal, the macro BS operates the interference avoidance interval as shown in FIG. 9.

FIG. 9 illustrates a method for allocating resources at a macro BS according to an exemplary embodiment of the present invention.

Referring to FIG. 9, in step 901 the macro BS generates one or more groups with the small BSs positioned in its cell coverage area. For example, the macro BS generates the groups of the small BSs by taking into account the location information provided from the small BSs positioned in its cell coverage area. The macro BS allocates a group ID, which is a unique ID, to each small BS group.

In step 903, the macro BS defines the interference avoidance intervals for the small BS groups generated in step 901. The macro BS sets the interference avoidance intervals for the small BS groups not to overlap each other. For example, the macro BS sets the interference avoidance intervals of the small BS groups not to overlap each other as shown in FIG. 4.

In step 905, the macro BS transmits the group ID of the small BS group and the interference avoidance interval information of the small BS group to the small BSs positioned in the cell. For example, the macro BS transmits the group ID of the small BS group and the interference avoidance interval information defined in the small BS group to the small BSs positioned in the cell over the wired network or the backhaul. Alternatively, the macro BS transmits only the interference avoidance interval information defined in the small BS group to the small BSs positioned in the service coverage over the wired network or the backhaul. Accordingly, the small BSs can determine their small BS group and obtain the interference avoidance interval information of the corresponding small BS group, from the information received from the macro BS.

In step 907, the macro BS determines whether the interference avoidance resource request message is received from the macro terminal.

If it is determined in step 907 that the interference avoidance resource request message is received, the macro BS determines the ID information of the small BS exerting the interference on the terminal, in the interference avoidance resource request message in step 909. On the other hand, if it is determined in step 907 that the interference avoidance resource request message is not received, the macro BS continues execution of step 907.

In step 911, the macro BS determines the small BS group including the small BS.

In step 913, the macro BS transmits the information of the small BS group, determined in step 911, to the terminal which sends the interference avoidance resource request message. For example, the macro BS transmits the small BS group information using the MAC operation message. The macro BS transmits the information of the small BS group to the terminal which sends the interference avoidance resource request message or transmits the information to every terminal positioned in the service coverage area. Herein, the small BS group information may include the ID of the small BS group and the ID information of the small BSs of the small BS group.

In step 915, the macro BS allocates the resource to the terminal using the resource designated as the interference avoidance interval of the small BS group determined in step 911. When fixedly allocating the resource different from the resource designated as the interference avoidance interval of the small BS group determined in step 911 to the macro terminal, the macro BS changes the fixed allocation resource of the macro terminal to the resource defined as the interference avoidance interval of the small BS group determined in step 911.

In step 917, the macro BS transmits the resource allocation information to the terminal.

Next, the macro BS finishes this process.

As stated above, the macro BS sets the interference avoidance intervals of the small BS groups not to overlap each other. In so doing, the macro BS may update the small BS groups on a periodic basis or when an addition/removal event of the small BS occurs.

In yet another exemplary embodiment, the macro BS transmits the information of the small BS group and then the resource allocation information. Alternatively, the macro BS may transmit the information of the small BS group after transmitting the resource allocation information. Alternatively, the macro BS may transmit the resource allocation information and the information of the small BS group at the same time.

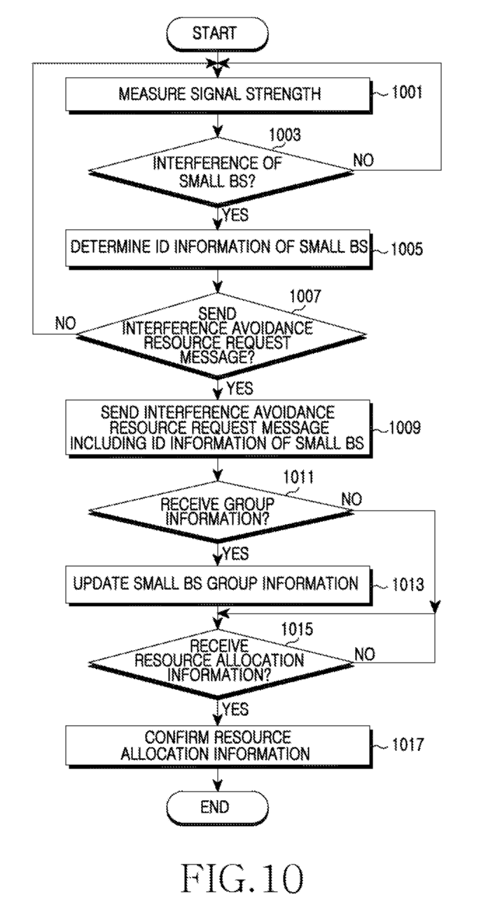

When the macro BS sends the small BS group information according to the request of the terminal as aforementioned, the macro terminal may function as shown in FIG. 10.

FIG. 10 illustrates a method for cancelling interference of a small BS at a terminal serviced by a macro BS according to an exemplary embodiment of the present invention.

Referring to FIG. 10, in step 1001 the terminal measures the signal strength of the macro BS servicing the terminal and one or more small BSs. For example, the terminal measures the signal strength using the SCH or the preamble transmitted from the macro BS and one or more small BSs. Herein, the signal strength includes CINR or RSSI.

In step 1003, the terminal determines if interference is received from the small BS. For example, the terminal compares the average signal strength of the macro BS measured for a certain time period with the average strength of the small BS. When the average signal strength of the macro BS is lower than the average signal strength of the small BS by more than a reference value, the terminal recognizes the signal received from the small BS as interference. Alternatively, when the movement speed of the terminal is greater than a reference speed and the average signal strength of the macro BS measured for a certain time period is lower than the average signal strength of the small BS by more than the reference value, the terminal recognizes the signal received from the small BS as interference. Herein, the reference value is a positive number including zero.

If it is determined in step 1003 that small BS interference does not occur, the terminal returns to step 1001 and re-measures the signal strength of the macro BS servicing the terminal and the signal from the neighboring small BSs.

On the other hand, if it is determined in step 1003 that small BS interference does occur, the terminal determines the ID information of the small BS exerting the interference in step 1005. For example, the terminal can determine the physical layer ID of the small BS using the SCH or the preamble. When the macro BS cannot determine the small BS merely with the cell ID, the terminal needs to determine the unique BS ID of the small BS. The terminal may determine the BS ID of the small BS using the mapping information of the cell ID provided from the macro BS and the BS ID and the cell ID of the small BS acquired from the SCH or the preamble. Alternatively, the terminal can determine the cell ID of the small BS based on the SCH or the preamble. Next, the terminal may be able to determine the BS ID of the small BS through the BCH of the small BS decoded using the cell ID.

In step 1007, the terminal determines whether to send the interference avoidance resource request message to the macro BS providing the service. For example, the terminal determines whether it holds the small BS group information provided from the macro BS. Without the small BS group information, the terminal recognizes no resource allocation of the interference avoidance interval. Thus, the terminal sends the interference avoidance resource request message.

With the small BS group information, the terminal determines whether to send the interference avoidance resource request message according to whether its small BS group information includes the small BS determined in step 1005. That is, the terminal stores only the small BS group information of the small BS previously exerting the interference. When the small BS group information held by the terminal includes the small BS determined in step 1005, the terminal determines not to send the interference avoidance resource request message because it can avoid the interference of the small BS using the previously allocated resource.

When the small BS group information of the terminal does not include the small BS determined in step 1005, the terminal needs to be allocated the resource of the interference avoidance interval different from the previously allocated resource in order to avoid the interference of the small BS. For doing so, the terminal determines to send the interference avoidance resource request message.

If it is determined in step 1007 not to send the interference avoidance resource request message, the terminal returns to step 1001 and re-measures the signal strength of the macro BS servicing the terminal and the one or more small BSs. That is, because the terminal holds the small BS group information of the small BS determined in step 1005, the terminal recognizes the allocation of the resource designated as the interference avoidance interval of the small BS group. Accordingly, the terminal can avoid the interference of the small BS determined in step 1005 merely by using the resource pre-allocated from the macro BS.

On the other hand, if it is determined in step 1007 to send the interference avoidance resource request message, the terminal sends the interference avoidance resource request message including the ID information of the small BS determined in step 1005, to the macro BS in step 1009.

In step 1011, the terminal determines whether the small BS group information is received from the macro BS. For instance, the terminal examines, based on the MAC operation message, whether the small BS group information is received from the macro BS.

If it is determined in step 1011 that the small BS group information is received, the terminal updates its stored small BS group according to the small BS group information received from the macro BS in step 1013. When not storing the small BS group information, the terminal stores the small BS group information received from the macro BS. Herein, the small BS group information includes the ID of the small BS group and the ID information of the small BSs of the small BS group. If it is determined in step 1011 that the small BS group information is not received, the terminal proceeds to step 1015.

In step 1015, the terminal determines whether the resource allocation message is received from the macro BS.

When not receiving the small BS group information within a certain time period in step 1011, the terminal determines whether the resource allocation message is received from the macro BS in step 1015.

If it is determined in step 1015 that the resource allocation message from the macro BS is received, the terminal determines the resource allocated from the macro BS based on the resource allocation message in step 1017. Alternatively, if it is determined in step 1015 that the resource allocation message from the macro BS is not received, the terminal continues execution of step 1015.

Next, the terminal finishes this process.

In yet another exemplary embodiment, the terminal determines the information of the small BS group including the small BS exerting the interference and then determines the resource allocation information, according to the transmission order of the macro BS.

Alternatively, the terminal may determine the resource allocation information and then the information of the small BS group according to the transmission order of the macro BS.

Now, descriptions are provided of an exemplary structure of a macro BS for setting interference avoidance intervals of the small BS groups not to overlap each other so as to raise the resource efficiency of the small BS.

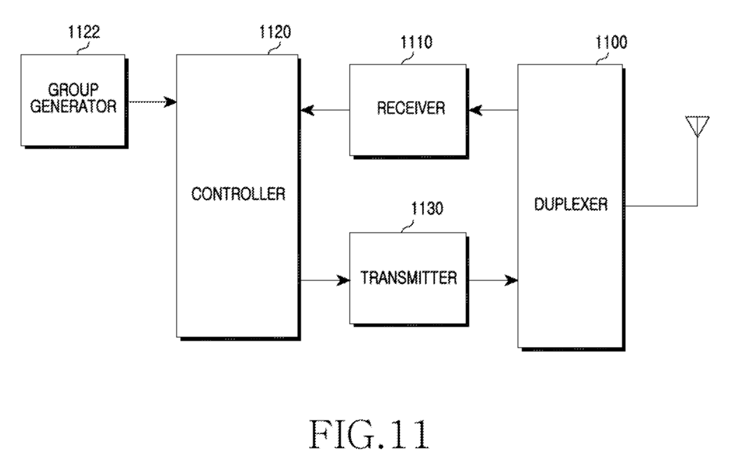

FIG. 11 is a block diagram of a macro BS according to an exemplary embodiment of the present invention.

The macro BS of FIG. 11 includes a duplexer 1100, a receiver 1110, a controller 1120, a group generator 1122, and a transmitter 1130.

The duplexer 1100 transmits a signal output from the transmitter 1130 over an antenna and forwards a Radio Frequency (RF) signal received by the antenna to the receiver 1110 in a duplexing manner.

The receiver 1110 converts the RF signal received from the duplexer 1100 into a baseband signal. For example, using an Orthogonal Frequency Division Multiplexing (OFDM) scheme, the receiver 1110 includes an RF processor, an OFDM demodulator, and a decoder. The RF processor converts the RF signal fed from the duplexer 1100 into the baseband signal. The OFDM demodulator converts the time-domain signal output from the RF processor into a frequency-domain signal through a Fast Fourier Transform (FFT) operation. The decoder demodulates and decodes the signal output from the OFDM demodulator at a corresponding modulation level. Herein, the modulation level includes a Modulation and Coding Scheme (MCS) level.

The controller 1120 controls the operations of the macro BS to reject the small cell interference for the macro terminal. The controller 120 cancels the small cell interference by allocating the resource of the interference avoidance interval to the terminal that receives interference from the small BS. For example, to cancel the small cell interference, the controller 1120 sets the interference avoidance interval such that all of the small cells operate using the same interference avoidance interval as shown in FIG. 2. Alternatively, to reject the small cell interference, the controller 1120 defines the interference avoidance interval such that the small BS groups operate using the different interference avoidance intervals as shown in FIG. 4. The controller 1120 operates using the interference avoidance interval as shown in FIG. 5, FIG. 7, or FIG. 9 depending on whether the macro BS transmits the small BS group information.

The group generator 1122 groups one or more small BSs positioned in the macro cell into at least one small BS group under the control of the controller 1120. For example, the group generator 1122 groups the small BSs by taking into account the location information of the small BSs.

The transmitter 1130 converts the data or the control signal to send to the upper node into an RF signal. For example, in conformity with the OFDM scheme, the transmitter 1130 includes an encoder, an OFDM modulator, and an RF processor. The encoder encodes and modulates the data or the control signal to send to the upper node at the corresponding modulation level. The OFDM modulator converts the frequency-domain signal output from the encoder to a time-domain signal through an Inverse FFT (IFFT) operation. The RF processor converts the baseband signal output from the OFDM modulator into the RF signal.

Although it is not depicted in the drawing, the macro BS includes a wired interface for communicating with the neighbor macro BS or the small BS over a wired network. The wired interface transmits the group information output from the group generator 1122 and the interference avoidance interval information allocated to the groups at the controller 1120 to the small BSs positioned in the macro cell.

The controller 1120 can function as the group generator 1122. The controller 1120 and the group generator 1122 are separately illustrated to distinguish their functions. In actual implementation, the controller 1120 can process all or part of the functions of the group generator 1122.

The following explanation describes an exemplary structure of a terminal for cancelling small cell interference under a control of a macro BS.

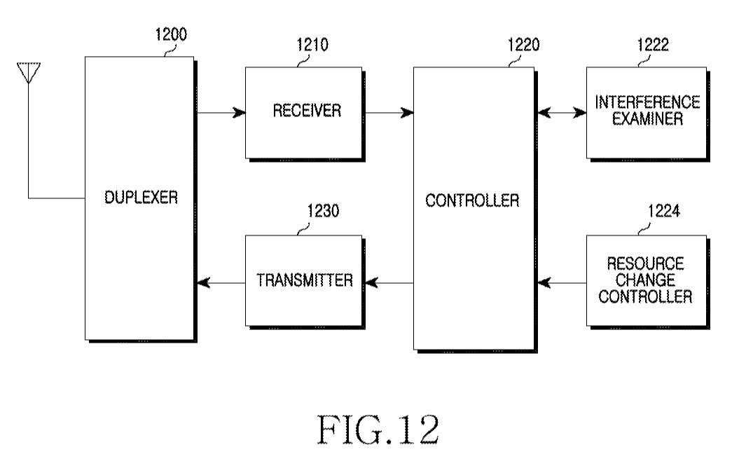

FIG. 12 illustrates a terminal according to an exemplary embodiment of the present invention.

Referring to FIG. 12, the terminal includes a duplexer 1200, a receiver 1210, a controller 1220, an interference examiner 1222, a resource change controller 1224, and a transmitter 1230.

The duplexer 1200 transmits a signal output from the transmitter 1230 over an antenna and forwards an RF signal received by the antenna to the receiver 1210 in a duplexing manner.

The receiver 1210 converts the RF signal fed from the duplexer 1200 to a baseband signal. For example, using the OFDM scheme, the receiver 1210 includes an RF processor, an OFDM demodulator, and a decoder. The RF processor converts the RF signal fed from the duplexer 1200 to the baseband signal. The OFDM demodulator converts the time-domain signal output from the RF processor to a frequency-domain signal through the FFT operation. The decoder demodulates and decodes the signal output from the OFDM demodulator at the corresponding modulation level. Herein, the modulation level includes the MCS level.

The controller 1220 controls the operations of the terminal to address the small cell interference. When the interference examiner 1222 determines the small cell interference, the controller 1220 requests the interference avoidance resource allocation to the macro BS to address the small cell interference. For example, when not knowing the small BS group information, the controller 1220 controls to send the interference avoidance resource request message including the ID information of the small BS exerting the interference. Alternatively, when knowing the small BS group information, the controller 1220 determines whether or not to send the interference avoidance resource request message using the resource change controller 1224. To send the interference avoidance resource request message, the controller 1220 controls to send the interference avoidance resource request message including the ID information or the group ID of the small BS exerting the interference.

The controller 1220 controls to communicate using the resource allocated from the macro BS. When the macro BS allocates the resource of the interference avoidance interval according to the interference avoidance resource request message, the controller 1220 can reject the small cell interference based on the resource allocation information allocated from the macro BS.

The interference examiner 1222 checks for the small cell interference under the control of the controller 1220. For example, when the signal strength average of the macro BS is lower than the signal strength average of the small BS, the interference examiner 1222 recognizes the signal received from the small BS as interference. In so doing, the interference examiner 1222 can add the reference value of a certain magnitude to the signal strength average of the macro BS and then compare with the signal strength average of the small BS.

Alternatively, when the movement speed is greater than the reference speed and the signal strength average of the macro BS is lower than the signal strength average of the small BS, the interference examiner 1222 recognizes the signal received from the small BS as interference. In so doing, the interference examiner 1222 may add the reference value of a certain magnitude to the signal strength average of the macro BS and then compare with the signal strength average of the small BS.

When knowing the small BS group information, the resource change controller 1224 determines whether to send the interference avoidance resource request message under the control of the controller 1220. For instance, when knowing the information of every small BS group, the resource change controller 1224 determines whether or not to send the interference avoidance resource request message by comparing the small BS group which sets the resource allocated from the macro BS as the interference avoidance interval with the small BS group including the small BS exerting the interference. When the small BS groups are not the same, the resource change controller 1224 determines to send the interference avoidance resource request message.

Alternatively, when knowing the small BS group information which sets the resource allocated from the macro BS as the interference avoidance interval, the resource change controller 1224 determines whether to send the interference avoidance resource request message depending on whether or not the small BS group information includes the small BS which exerts the interference. When the small BS group information does not include the small BS, the resource change controller 1224 determines to send the interference avoidance resource request message.

The transmitter 1230 converts the data or the control signal to send to the upper node to the RF signal. For example, in conformity with the OFDM scheme, the transmitter 1230 includes an encoder, an OFDM modulator, and an RF processor. The encoder encodes and modulates the data or the control signal to send to the upper node at the corresponding modulation level. The OFDM modulator converts the frequency-domain signal output from the encoder to a time-domain signal through the IFFT operation. The RF processor converts the baseband signal output from the OFDM modulator to the RF signal.

As constructed above, the controller 1220 can function as the interference examiner 1222 and the resource change controller 1224. The controller 1220, the interference examiner 1222, and the resource change controller 1224 are separately illustrated to distinguish their functions. In the actual implementation, the controller 1224 can process all or part of the functions of the interference examiner 1222 and the resource change controller 1224.

According to an exemplary embodiment of the present invention, the macro BS defines the interference avoidance intervals such that the small BS groups operate using the different interference avoidance intervals. At this time, the macro BS defines the interference avoidance interval by grouping hot zone BSs installed in the outside public places.

According to an exemplary embodiment of the present invention, when the macro cell covers a plurality of hot zone BSs and a plurality of femto BSs, the macro BS can set the different interference avoidance intervals by grouping the hot zone BSs and the femto BSs into different small BS groups. The group of the hot zone BSs may be divided into a plurality of small BS groups and thus the different interference avoidance intervals may be set for the small BS groups respectively. The group of the femto BSs may be divided into a plurality of small BS groups and thus the different interference avoidance intervals may be set for the small BS groups respectively. Herein, the femto BS represents an indoor small BS.

In the above exemplary embodiments, the wireless communication system adopting the TDD scheme sets the interference avoidance interval using the time resource.

According to an exemplary embodiment of the present invention, the wireless communication system adopting a Frequency Division Duplex (FDD) scheme can set the interference avoidance interval using the frequency resource.

As set forth above, by defining the interference avoidance interval unusable by the small BS in the wireless communication system including the macro cell and the small cells together, it is possible to cancel the small cell interference on the terminal which receives the macro cell service.

By defining the different interference avoidance intervals for one or more small BS groups, the capacity loss of the small BS according to the interference avoidance interval can be reduced and the overhead for reallocating the resource to the terminal of the fixedly allocated resource can be mitigated.

Furthermore, it is possible to diminish the signaling overhead in transmitting the interference avoidance resource request message based on the small BS group information.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for avoiding small cell interference at a macro Base Station (BS) in a wireless communication system which comprises the macro BS and at least one small BS using the same frequency band, the method comprising:
when receiving an interference avoidance resource request signal from at least one terminal to which a macro cell service is provided, determining a small BS which exerts interference on the terminal;
determining an interference avoidance interval not used by the small BS which exerts the interference on the terminal; and
allocating a resource to the terminal using a resource of the interference avoidance interval not used by the small BS.

2. The method of claim 1, further comprising:
setting an interference avoidance interval in which a resource is not used by at least one small BS,
wherein the determining of the interference avoidance interval comprises:
confirming the interference avoidance interval in which the resource is not used by the small BS exerting the interference on the terminal.

3. The method of claim 2, wherein the setting of the interference avoidance interval comprises:
generating one or more small BS groups comprising at least one small BS; and
setting an interference avoidance interval for each small BS group such that the interference avoidance intervals of the small BS groups do not overlap each other.

4. The method of claim 2, further comprising:
after setting the interference avoidance interval, sending interference avoidance interval information to at least one terminal.

5. The method of claim 2, further comprising:
after setting the interference avoidance interval, sending interference avoidance interval information to at least one small BS.

6. The method of claim 1, wherein the allocating of the resource comprises:
determining whether a resource allocated to provide the service to the terminal which sends the interference avoidance resource request signal belongs to the interference avoidance interval not used by the small BS which exerts the interference on the terminal;
when the resource allocated to provide the service to the terminal does not belong to the interference avoidance interval not used by the small BS which exerts the interference on the terminal, allocating the resource to the terminal using the resource of the interference avoidance interval not used by the small BS; and
when the resource allocated to provide the service to the terminal belongs to the interference avoidance interval not used by the small BS which exerts the interference on the terminal, maintaining the resource allocated to the terminal.

7. A method for avoiding small cell interference at a terminal in a wireless communication system which comprises a macro Base Station (BS) and at least one small BS using the same frequency band, the method comprising:
when receiving a service from the macro BS, determining a signal strength of the macro BS and the at least one small BS;
determining whether there is a small BS which exerts interference, by determining the signal strength of the macro BS and the at least one small BS; and
if it is determined that the small BS is exerting interference, requesting the macro BS to allocate a resource of an interference avoidance interval unusable by the small BS.

8. The method of claim 7, wherein the requesting of the resource of the interference avoidance interval comprises:
determining ID information of the small BS which exerts the interference; and
sending an interference avoidance resource request signal, comprising the ID information of the small BS, to the macro BS.

9. The method of claim 8, further comprising:
after determining the ID information of the small BS, determining whether information of a small BS group comprising the small BS is contained therein,
wherein, when the information of the small BS group comprising the small BS is not contained therein, an interference avoidance resource request signal comprising the ID information of the small BS is transmitted to the macro BS.

10. The method of claim 7, wherein the requesting of the resource allocation of the interference avoidance interval comprises:
if it is determined that the small BS is exerting interference, determining a small BS group which comprises the small BS exerting the interference; and
sending an interference avoidance resource request signal comprising any one of ID information of the small BS and ID information of the small BS group to the macro BS.

11. The method of claim 10, further comprising:
after determining the small BS group, determining whether the interference avoidance interval of the small BS group comprises the resource allocated from the macro BS;
when the interference avoidance interval of the small BS group does not comprise the resource allocated from the macro BS, determining to send the interference avoidance resource allocation request signal; and
when the interference avoidance interval of the small BS group comprises the resource allocated from the macro BS, determining not to send the interference avoidance resource allocation request signal.

12. An apparatus for avoiding small cell interference at a macro Base Station (BS) in a wireless communication system which comprises the macro BS and at least one small BS using the same frequency band, the apparatus comprising:
a receiver for receiving a signal; and
a controller for, when receiving an interference avoidance resource request signal from at least one terminal to which a macro cell service is provided, through the receiver, determining an interference avoidance interval not used by the small BS which exerts the interference on the terminal and allocating a resource to the terminal using a resource of the interference avoidance interval not used by the small BS.

13. The apparatus of claim 12, wherein the controller sets an interference avoidance interval in which a resource is not used by at least one small BS.

14. The apparatus of claim 13, further comprising:
a group generator for generating one or more small BS groups comprising at least one small BS,
wherein the controller sets an interference avoidance interval for each small BS group such that the interference avoidance intervals of the small BS groups do not overlap each other.

15. The apparatus of claim 13, further comprising:
a transmitter for sending the interference avoidance interval information set by the controller to at least one terminal.

16. The apparatus of claim 13, further comprising:
a wired interface for sending the interference avoidance interval information set by the controller to at least one small BS.

17. The apparatus of claim 12, wherein, when the resource allocated to provide the service to the terminal which sends the interference avoidance resource request signal does not belong to the interference avoidance interval not used by the small BS which exerts the interference on the terminal, the controller allocates the resource to the terminal using the resource of the interference avoidance interval not used by the small BS, and
when the resource allocated to provide the service to the terminal belongs to the interference avoidance interval not used by the small BS which exerts the interference on the terminal, the controller controls to maintain the resource allocated to the terminal.

18. An apparatus for avoiding small cell interference at a terminal in a wireless communication system which comprises a macro Base Station (BS) and at least one small BS using the same frequency band, the apparatus comprising:
a receiver for receiving a signal;
an interference examiner for determining whether there is a small BS which exerts interference by taking into account a signal strength of the macro BS and the at least one small BS acquired using the signal received through the receiver;
a controller for, if it is determined that the small BS is exerting interference, requesting the macro BS to allocate a resource of an interference avoidance interval not usable by the small BS; and
a transmitter for requesting the macro BS to allocate the resource of the interference avoidance interval under control of the controller.

19. The apparatus of claim 18, wherein the transmitter sends an interference avoidance resource request signal comprising ID information of the small BS which exerts the interference, to the macro BS.

20. The apparatus of claim 18, wherein, when not having information of the small BS group comprising the small BS exerting the interference, the controller controls to request the macro BS to allocate the resource of the interference avoidance interval comprising ID information of the small BS.

21. The apparatus of claim 18, wherein, when the interference avoidance interval of the small BS group comprising the small BS exerting the interference does not comprise the resource allocated from the macro BS, the controller controls to send an interference avoidance resource request signal, and
when the interference avoidance interval of the small BS group comprises the resource allocated from the macro BS, the controller controls not to send an interference avoidance resource allocation request signal.

22. The apparatus of claim 18, wherein the transmitter sends an interference avoidance resource request signal comprising any one of ID information of the small BS and ID information of the small BS group to the macro BS under the control of the controller.
